(19) United States
(12) Patent Application Publication
(10) Pub. No.: US 2019/0047374 A1
(43) Pub. Date: Feb. 14, 2019

(54) AIR VENT

(71) Applicant: fischer automotive systems GmbH & Co. KG, Horb a.N. (DE)

(72) Inventor: Falk SCHAAL, Freudenstadt (DE)

(21) Appl. No.: 15/997,730

(22) Filed: Jun. 5, 2018

(30) Foreign Application Priority Data
Aug. 9, 2017 (DE) 10 2017 118 055.9

(51) Int. Cl. B60H 1/34; F24F 13/072; F24F 13/14

(52) U.S. Cl. CPC B60H 1/3421; B64D 2013/0625; F24F 13/14; F24F 13/072

(57) ABSTRACT

In an air vent for a motor vehicle, a control surface mechanism includes a fixed fin and two congruent rudders at a rear end of the fin in a flow direction, which can be pivoted away from one another in a V shape so as to guide an air current to one side.

### CROSS-REFERENCE TO RELATED APPLICATIONS

This application claims priority under 35 USC § 119 to German Patent Application No. 10 2017 118 055.9, filed on Aug. 9, 2017, the entire disclosure of which is incorporated herein by reference.

### TECHNICAL FILED

Air vents are used to ventilate a passenger compartment of motor vehicles.

### BACKGROUND ART

The patent DE 10 2013 210 055 B3 discloses an air vent comprising a rectangular tube-shaped housing, in which a flow-around body is fixedly disposed. The flow-around body extends transversely through the housing from one side to an opposite side and is located in a section in which the housing widens in a curve-shaped manner perpendicularly to the flow-around body and tapers again to form a rectangular air outlet opening. The flow-around body divides the housing into two channels in the widened section. On an incident flow side of the flow-around body, which is to say on a side facing an air inlet opening of the housing, a rudder is disposed so as to pivot upward and downward, by way of which a ratio of air volumes flowing into the two channels between the flow-around body and the housing can be set and, in the end positions, a respective one of the two channels can be closed by the rudder. The ratio of the air volumes flowing through the two channels influences an outflow direction of air out of the air outlet opening of the housing of the known air vent, since the air flows out of the two channels obliquely toward one another through the air outlet opening.

### SUMMARY

An object of the invention is to propose an air vent that enables low flow resistance.

An airvent as described herein includes a tubular housing having an air inlet opening and an air outlet opening. The housing can have a rectangular, an oval, a circular or any arbitrary cross-section. A control surface mechanism comprising a fixed fin and two pivotable rudders, which are disposed on the fin, is disposed in the housing. The terminology is based on control surface mechanisms used in aircraft. The two rudders can be pivoted about mutually parallel pivot axes, and in particular they can be pivoted away from one another into a position that diverges in a V-shaped manner, seen from one side, and toward one another, preferably into a position in which they are parallel to and/or bear against one another. The rudders can preferably be individually pivoted and thus do not have to be pivoted synchronously. The two rudders allow an air current to be guided through the housing of the air vent and enable air to flow out of the air outlet opening of the housing in a linear manner or obliquely with respect to one or an opposite side.

A distance between the pivot axes of the two rudders is preferably no greater than the thickness of the fixed fin. In this way, the pivot axes of the rudders can be disposed within the fixed fin, seen in the flow direction.

One embodiment of the invention provides for two rudders that are congruent as seen in a view. When the rudders bear against one another or aligned parallel with one another, they are congruent as seen in a view.

One embodiment of the invention provides for the two pivotable rudders, together, to be no thicker than the fixed fin. In this way, it is possible that, seen in the flow direction through the housing, the two rudders do not protrude beyond the fin when they are pivoted together into a position in which they bear against one another and/or a position in which they are parallel to one another and/or to the fin.

Preferably, the rudders do not have any offset at a transition from the fixed fin to the pivotable rudders. Surfaces of the fin facing away from one another transition without steps into surfaces of the rudders facing away from one another. When the two rudders are pivoted together, the surfaces of the fin transition, preferably steadily, into surfaces of the rudders. When the rudders are pivoted away from one another, the surfaces of the fin transition into the surfaces of the rudders with a bend.

One embodiment of the invention provides for the pivotable rudders to be disposed downstream of the fixed fin of the control surface mechanism, in a flow direction through the housing of the air vent.

One embodiment of the invention provides for a recess in the fixed fin, in which the two rudders are disposed.

One embodiment of the invention provides for the pivot axes of the rudders to be disposed at the ends thereof experiencing incident flow, which is to say the ends facing the air inlet opening of the housing, or close to these ends of the rudders. In this embodiment of the invention, the pivot axes, in any case, are located closer to the end of the rudders facing the air inlet opening of the housing than to the end of the rudders facing the air outlet opening. In this embodiment of the invention, an air current flowing through the housing from the air inlet opening to the air outlet opening acts on the two rudders so as to move these together, and so that these do not move apart.

The air vent according to the invention is provided for ventilating passenger compartments, in particular of motor vehicles and, in general, of land vehicles, aircraft and watercraft. In essence, the invention can be used for venting and ventilating any chamber used by people or not used by people. Further uses are not excluded.

### BRIEF DESCRIPTION OF THE DRAWINGS

The invention will be described in more detail hereafter based on two exemplary embodiments shown in the drawings. In the drawings:

FIGS. 1a to 1c show an air vent according to the invention in a cutaway view and in a perspective illustration, in different positions;

FIGS. 2a to 2c show the air vent from FIGS. 1a to 1c in a longitudinal sectional view; and

FIG. 3 shows a second exemplary embodiment of an air vent according to the invention in a cutaway perspective illustration corresponding to FIG. 1c.

### DETAILED DESCRIPTION

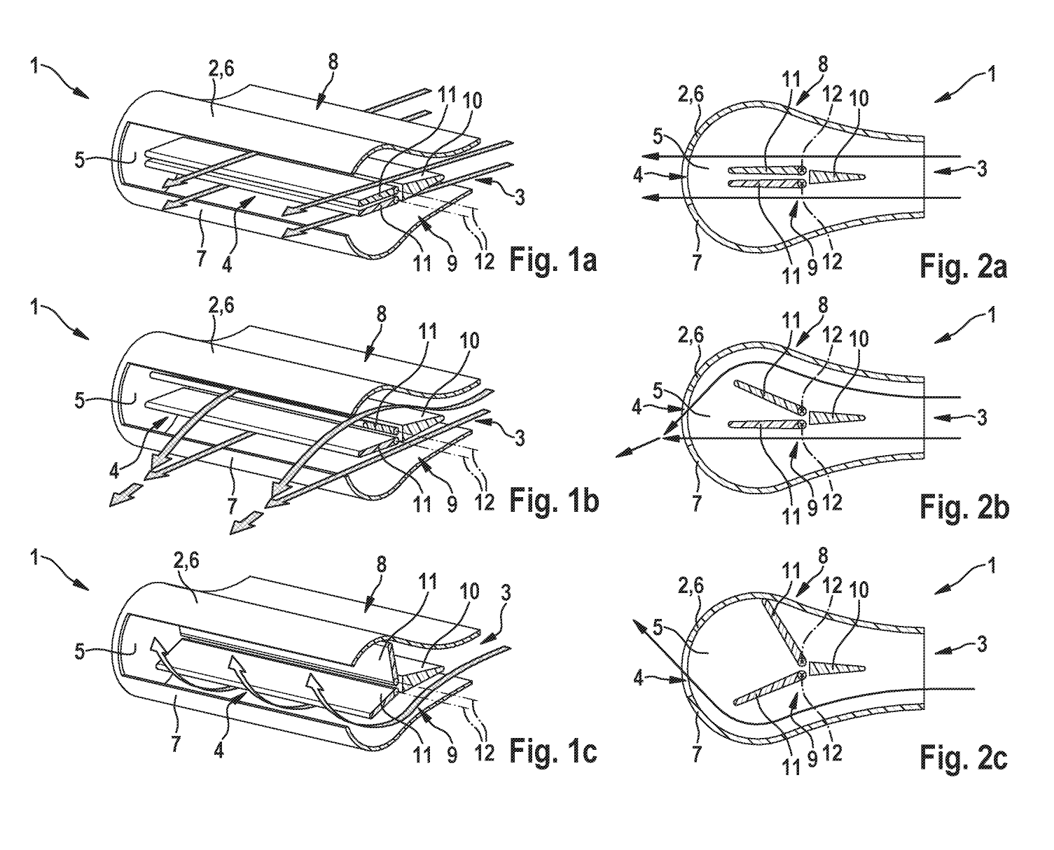

The air vent 1 according to the invention, shown in FIGS. 1a to 1c and 2a to 2c, comprises a rectangular tube-shaped housing 2 having a rectangular air inlet opening 3 and a likewise rectangular air outlet opening 4. Two mutually opposing walls of the housing 2, which are referred to as side walls 5 here, are parallel to one another. Two other, likewise mutually opposing walls of the housing 2, which are referred to as the top side 6 and the bottom side 7 here, extend, starting from the air inlet opening 3, initially parallel to one another, and subsequently away from one another in an S-shaped manner, and then together again in an arc-shaped manner, up to the air outlet opening 4, wherein a widened section 8 of the tubular housing 2 is formed. The top side 6, the bottom side 7 and the side walls 5 of the housing 2 do not have to be located at the top, at the bottom and on the sides; this is dependent on a spatial arrangement of the housing 2. The designations were selected for a clear and unambiguous description.

A control surface mechanism 9 comprising a fixed fin 10 and two pivotable rudders 11 is disposed in the widened section 8 of the housing 2. The fixed fin 10 and the rudders 11 are strip-shaped and extend transversely from the one side wall to the opposite side wall 5 of the housing 2 of the air vent 1 according to the invention. The fixed fin 10 is located in a center plane between the top side 6 and the bottom side 7 of the housing 2. The pivotable rudders 11 adjoin the fin 10 on an end of the fin 10 facing the air outlet opening 4. Pivot axes 12 of the rudders 11 extend parallel to the fin 10 and the rudders 11 on, or close to, ends of the rudders 11 facing the fin 10 and the air inlet opening 3.

The rudders 11 can be pivoted together to assume a position shown in FIGS. 1a and 2a, in which they bear against one another and are disposed parallel to one another and to the center plane of the housing 2 between the top side 6 and the bottom 7 and extend the fin 10 in a linear manner. The rudders 11 can be pivoted away from one another, as is shown in FIGS. 1b and 1c and 2b and 2c, so that the rudders 11, seen from one side, form a V having a settable angle. The two rudders 11 can be pivoted individually, independently of one another and continuously.

In a top view of the rudders 11, the rudders 11 are congruent. Together, the rudders 11 are as thick as the fin 10, whereby no offset results at a transition from the fin 10 to the rudders 11, but surfaces of the fin 10 facing away from one another transition, in a linear manner, into surfaces of the rudders 11 facing away from one another when the rudders 11 are pivoted together into the position that is parallel to the center plane of the housing 2, and the surfaces of the fin 10 facing away from one another transition at an angle into the surfaces of the rudders 11 facing away from one another when the rudders 11 are pivoted apart. A distance between the pivot axes 12 of the rudders 11 has the size of the thickness of the rudders 11, and half the size of the thickness of the fin 10.

When the two rudders 11 are pivoted together, as is shown in FIGS. 1a, 2a, these essentially produce no flow resistance, and a flow through the housing 2 takes place in a linear manner from the air inlet opening 3 to the air outlet opening 4, as is indicated by the arrows.

When one of the rudders 11 is pivoted away from the other rudder 11, as is shown in FIGS. 1b and 2b, the air on this side of the control surface mechanism 9 flows in an arc-shaped manner around the rudder 11 and, due to the tapering of the housing 2 of the air vent 1 according to the invention toward the air outlet opening 4, flows obliquely out of the air outlet opening 4 of the housing 2 toward the other side. In doing so, the air current flowing around one side of the control surface mechanism 9 in an arc-shaped manner deflects the air current on the other side of the control surface mechanism 9 likewise obliquely toward the side, as is illustrated by the arrows in FIGS. 1b, 2b.

The strongest deflection of an air current flowing through the housing 2 of the air vent 1 according to the invention results, as is shown in FIGS. 1c, 2c, when one of the rudders 11 is pivoted away from the other rudder 11 until an end of the rudder 11 lying furthest away from the fin 10 bears against the top side 6 or the bottom side 7 of the housing 2 and blocks air from passing through on this side of the control surface mechanism 9. At the same time, to achieve the strongest deflection of the air current toward the side, the other rudder 11 is pivoted to a certain degree away from the one rudder 11 toward the bottom side 7 or the top side 6 of the housing 2, whereby an air current flowing through the housing 2 flows around the other rudder 11 in an arc-shaped manner.

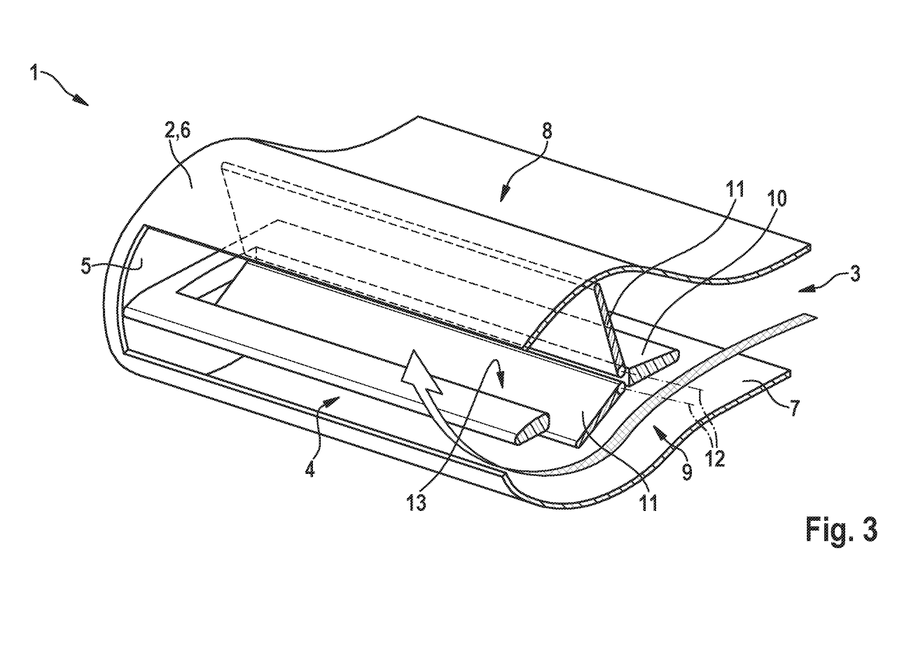

In contrast to FIGS. 1a to 1c and 2a to 2c, the fixed fin 10 of the control surface mechanism 9 of the air vent 1 from FIG. 3 has a rectangular recess 13 having the same shape and surface area as the rudders 11. The rudders 11 are disposed in the recess 13 of the fin 10 of the control surface mechanism 9 so as to pivot about the pivot axes 12. Otherwise, the air vent 1 from FIG. 3 has the same design, and functions in the same manner, as the air vent 1 from FIGS. 1a to 1c and 2a to 2c. So as to avoid repetition, reference is made to the above comments regarding FIGS. 1a to 1c and 2a to 2c for the description of FIG. 3.

The air vents 1 shown in the figures can additionally comprise louvers, and in particular movable louvers, which are disposed substantially perpendicularly to the fin 10 (not shown). So as to guide the air current obliquely with respect to the drawing plane of the FIGS. 2a to 2c, these louvers can be pivoted out of a position parallel to the side walls 5 into an oblique position, as is known from air vents.

However, the louvers can also be disposed in the region of the fin 10 upstream or downstream thereof, in the flow direction.

### LIST OF REFERENCE NUMERALS

### Air Vent

1 air vent
2 housing
3 air inlet opening
4 air outlet opening
5 side wall
6 top side
7 bottom side
8 widened section
9 control surface mechanism
10 fin
11 rudder
12 pivot axis
13 recess

1. An air vent, comprising a tubular housing, which comprises an air inlet opening, an air outlet opening and a control surface mechanism, which is disposed between the air inlet opening and the air outlet opening in the housing and comprises a fixed fin and a pivotable first rudder disposed on the fin, wherein the control surface mechanism comprises a second rudder disposed on the fixed fin, and the two rudders can be pivoted about mutually parallel pivot axes.

2. The air vent according to claim 1, wherein the two rudders can be pivoted away from one another and toward one another.

3. The air vent according to claim 1, wherein a distance between the two pivot axes is no greater than a thickness of the fixed fin or of the rudders.

4. The air vent according to claim 1, wherein the two rudders are congruent as seen in a view.

5. The air vent according to claim 1, wherein the two rudders together are no thicker than the fin.

6. The air vent according to claim 1, wherein the control surface mechanism does not have any offset at a transition from the fixed fin to the rudders.

7. The air vent according to claim 1, wherein the rudders are disposed downstream of the fixed fin of the control surface mechanism, in a flow direction through the housing.

8. The air vent according to claim 1, wherein pivot axes of the rudders are located closer to an end of the rudders facing the air inlet opening of the housing than to an end of the rudders facing the air outlet opening of the housing.

9. The air vent according to claim 1, wherein the fixed fin has a recess in which the two rudders are disposed.
